(19) United States
(12) Patent Application Publication
(10) Pub. No.: US 2026/0169119 A1
(43) Pub. Date: Jun. 18, 2026

(54) POSITION ESTIMATION APPARATUS, POSITION ESTIMATION SYSTEM, POSITION ESTIMATION METHOD, CONTROL CIRCUIT, AND STORAGE MEDIUM

(71) Applicant: Mitsubishi Electric Corporation, Tokyo (JP)

(72) Inventors: Shusaku UMEDA, Tokyo (JP); Hiroyasu SANO, Tokyo (JP); Akira KURITA, Tokyo (JP); Kota NAKAMURA, Tokyo (JP)

(73) Assignee: Mitsubishi Electric Corporation, Tokyo (JP)

(21) Appl. No.: 19/534,038

(22) Filed: Feb. 9, 2026

Related U.S. Application Data
(63) Continuation of application No. PCT/JP2024/015773, filed on Apr. 22, 2024.

(30) Foreign Application Priority Data
Aug. 31, 2023 (WO) PCT/JP2023/031919

(51) Int. Cl. G01S 5/14

(52) U.S. Cl. CPC G01S 5/14

(57) ABSTRACT

A position estimation apparatus that estimates a position of a mobile station based on distance measurement results between fixed stations and the mobile station includes: a distance calculation unit that calculates an estimated distance between the fixed stations and the mobile station; an error calculation unit that calculates an error between the distance measurement results and the estimated distances; a least squares method processing unit that calculates an adjustment amount of the estimated position based on distance errors and partial differentiation results of the estimated distances, the distance errors being the errors; and a position information updating unit that updates, based on the adjustment amount, position information indicating the estimated position, wherein the position estimation apparatus repeatedly executes estimated position update processing a predetermined number of times, the estimated position update processing including calculating the estimated distance, the error, and the adjustment amount, and updating the position information.

### CROSS-REFERENCE TO RELATED APPLICATION

This application is a continuation application of International Application PCT/JP2024/015773, filed on Apr. 22, 2024, and designating the U.S., which claims priority under 35 U.S.C. 119(a) to International Application PCT/JP2023/031919, filed on Aug. 31, 2023, the entire contents of which are incorporated herein by reference.

### BACKGROUND OF THE INVENTION

### 1. Field of the Invention

The present disclosure relates to a position estimation apparatus, a position estimation system, a position estimation method, a control circuit, and a storage medium for estimating a position of a target object using Ultra Wide Band (UWB) signals.

### 2. Description of the Related Art

There are techniques in which a distance between a fixed station fixed on the ground and a mobile station is measured based on a propagation time between the fixed station and the mobile station using a transmission and reception timing in UWB communication, and a position of the mobile station is estimated based on a distance measurement result obtained by measuring the distance, and a position of the fixed station. UWB signals transmitted and received between the mobile station and the fixed station for distance measurement are ultrashort pulse signals in the time domain. Thus, the use of UWB signals makes it possible to grasp the transmission and reception timing in communication with high resolution, to measure the distance with high accuracy, and thus, to estimate the position of the mobile station with high accuracy.

A typical position estimation algorithm used for performing position estimation is a least squares method of solving three-dimensional nonlinear simultaneous equations relating to positions of a plurality of fixed stations and distance measurement results between the fixed stations and the mobile station in order to estimate a three-dimensional position (x,y,z) of the mobile station, and the position of the mobile station is estimated by sequential approximate calculation. However, when reflected waves from a wall and the like are received by the fixed stations and the mobile station, pulse waveforms of the UWB signals are distorted, and thus, distance measurement results indicate distances greater than actual distances between the fixed stations and the mobile station. As a result, the distance measurement results with low accuracy are used for position estimation. Thus, there is a problem that the position of the mobile station cannot be appropriately estimated.

As a technique for solving such a problem, for example, Japanese Patent No. 4567093 discloses a method of identifying whether radio wave propagation between a fixed station and a mobile station is Line of Site (LOS) or Non-Line of Site (NLOS) based on statistical data of an amplitude and a delay of a UWB signal, and improving the accuracy of the estimation of the position based on an identification result. For the method disclosed in Japanese Patent No. 4567093, as the statistical data of the amplitude and the delay of the UWB signal at the time of reception, sharpness of the reception waveform of the UWB signals, average excess delay spread of multipath components, and delay spread of a root mean square are used.

However, the technique disclosed in Japanese Patent No. 4567093 requires advance collection of statistical data related to a multipath channel for an area where a radio wave environment is unknown, and, in a state where no statistical data is obtained in advance, is incapable of performing highly accurate position estimation, which is problematic. Thus, a technique is desired to be achieved, which is capable of performing highly accurate position estimation without requiring advance preparation such as data collection.

### SUMMARY OF THE INVENTION

In order to solve the above-described problems and achieve the object, a position estimation apparatus according to the present disclosure estimates a position of a mobile station based on distance measurement results between a plurality of individual fixed stations and the mobile station, the distance measurement results being derived based on results of wireless communication between the plurality of individual fixed stations and the mobile station. The position estimation apparatus includes: a distance calculation unit to calculate, for each of the fixed stations, an estimated distance based on an estimated position of the mobile station and positions of the plurality of fixed stations, the estimated distances being distances between the plurality of individual fixed stations and the mobile station; an error calculation unit to calculate, for each of the fixed stations, an error between the distance measurement results and the estimated distances; an estimated position adjustment amount calculation unit to calculate an adjustment amount of the estimated position based on distance errors and partial differentiation results of the estimated distances, the distance errors being the errors calculated by the error calculation unit; and a position information updating unit to update, based on the adjustment amount, position information indicating the estimated position, wherein the position estimation apparatus repeatedly executes estimated position update processing a predetermined number of times, thus estimating a position of the mobile station, the estimated position update processing including processing in which the distance calculation unit calculates the estimated distance for each of the fixed stations, processing in which the error calculation unit calculates the error for each of the fixed stations, processing in which the estimated position adjustment amount calculation unit calculates the adjustment amount, and processing in which the position information updating unit updates the position information.

### BRIEF DESCRIPTION OF THE DRAWINGS

FIG. 1 is a diagram illustrating an example of a configuration of a position estimation system according to a first embodiment;

FIG. 2 is a diagram illustrating an example of waveform distortion that occurs in a multipath environment;

FIG. 3 is a diagram illustrating a first example of a distance measurement result and a position estimation result;

FIG. 4 is a diagram illustrating a second example of the distance measurement result and the position estimation result;

FIG. 5 is a diagram illustrating an exemplary configuration of a position estimation apparatus according to the first embodiment;

FIG. 6 is a flowchart illustrating an example of an operation in which the position estimation apparatus according to the first embodiment estimates a position of a mobile station;

FIG. 7 is a diagram illustrating a relationship between distance measurement errors and a weighting coefficient in the position estimation apparatus according to the first embodiment;

FIG. 8 is a diagram for describing clip processing used in the position estimation apparatus according to the first embodiment;

FIG. 9 is a diagram illustrating an exemplary configuration of a position estimation apparatus according to a second embodiment;

FIG. 10 is a flowchart illustrating an example of an operation in which the position estimation apparatus according to the second embodiment estimates a position of the mobile station;

FIG. 11 is a diagram illustrating a first example of distance measurement errors between fixed stations and a mobile station;

FIG. 12 is a diagram illustrating a second example of distance measurement errors between the fixed stations and the mobile station;

FIG. 13 is a diagram illustrating a third example of distance measurement errors between the fixed stations and the mobile station;

FIG. 14 is a diagram illustrating an example of a weighting coefficient used in least squares method processing in a position estimation apparatus according to a third embodiment;

FIG. 15 is a diagram illustrating an exemplary configuration of a position estimation apparatus according to a fourth embodiment;

FIG. 16 is a flowchart illustrating an example of an operation in which the position estimation apparatus according to the fourth embodiment estimates a position of the mobile station;

FIG. 17 is a diagram illustrating a first example of a weighting coefficient used in least squares method processing in the position estimation apparatus according to the fourth embodiment;

FIG. 18 is a diagram illustrating a second example of the weighting coefficient used in the least squares method processing in the position estimation apparatus according to the fourth embodiment;

FIG. 19 is a diagram illustrating an exemplary configuration of a position estimation apparatus according to a fifth embodiment;

FIG. 20 is a flowchart illustrating an example of an operation in which the position estimation apparatus according to the fifth embodiment estimates a position of the mobile station;

FIG. 21 is a diagram illustrating an example of a case where a processor and a memory constitute processing circuitry included in the fixed stations or the mobile station according to the first to fifth embodiments; and

FIG. 22 is a diagram illustrating an example of a case where dedicated hardware constitutes processing circuitry included in the fixed stations or the mobile station according to the first to fifth embodiments.

### DETAILED DESCRIPTION OF THE PREFERRED EMBODIMENTS

Hereinafter, with reference to the drawings, a description will be given in detail of a position estimation apparatus, a position estimation system, a position estimation method, a control circuit, and a storage medium according to embodiments of the present disclosure.

### First Embodiment

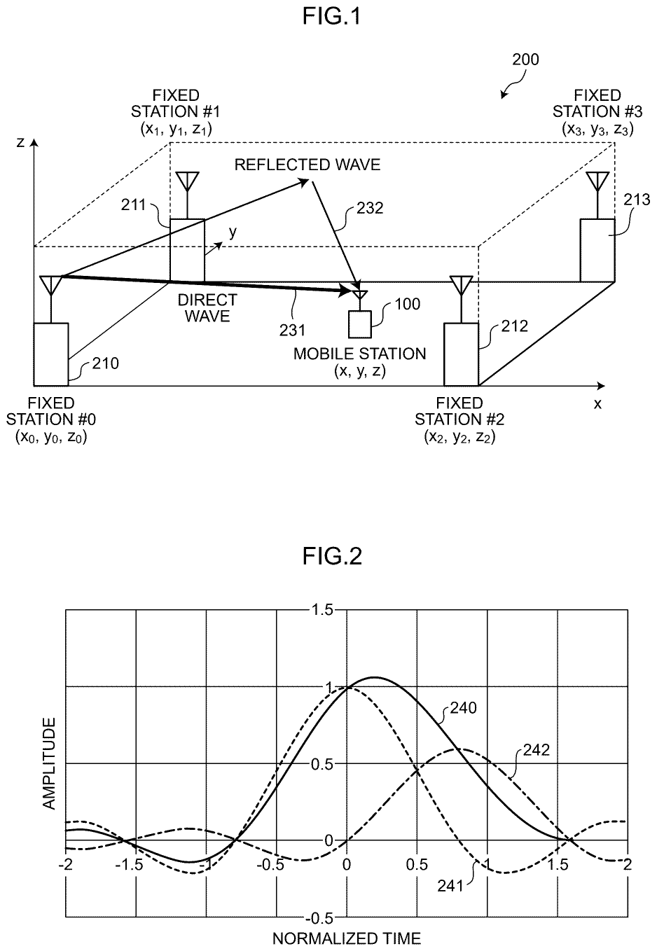

FIG. 1 is a diagram illustrating an example of a configuration of a position estimation system 200 according to a first embodiment. The position estimation system 200 includes a mobile station 100 having a function as a position estimation apparatus, and a plurality of fixed stations 210 to 213 fixed on the ground. Note that, in FIG. 1, the number of fixed stations included in the position estimation system 200 is four, but the position estimation system 200 may include five or more fixed stations. Additionally, in the following description, the fixed stations 210 to 213 may also be referred to as fixed stations #0 to #3, respectively. Additionally, the fixed stations 210 to 213 are denoted by no reference signs unless needed to be distinguished from each other, and may be simply referred to as the “fixed stations”.

The position estimation system 200 measures distances between the mobile station 100 and the individual fixed stations 210 to 213 based on transmission and reception timings of wireless signals transmitted and received by wireless communication between the mobile station 100 and the individual fixed stations 210 to 213, and estimates the position of the mobile station 100 based on a plurality of distance measurement results obtained by measuring the distances. Here, the wireless signals used by the position estimation system 200 are, for example, UWB signals. As described above, the use of the UWB signals makes it possible to grasp the transmission and reception timings in communication with high resolution, and to estimate the position of the mobile station 100. Note that, although in the present embodiment and second to fifth embodiments to be described later, a description will be given of an example in which distance measurement is performed using the UWB signals, each embodiment is also applicable to a system that performs distance measurement using wireless signals other than the UWB signals.

The positions of the mobile station 100 and the fixed stations 210 to 213 are represented by three-dimensional positions, and coordinate axes defining the three-dimensional space are an x-axis, a y-axis, and a z-axis. Assume that the positions of the fixed stations 210 to 213 are known, the position of the fixed station 210 (fixed station #0) is represented by (x₀,y₀,z₀), the position of the fixed station 211 (fixed station #1) is represented by (x₁,y₁,z₁), the position of the fixed station 212 (fixed station #2) is represented by (x₂,y₂,z₂), and the position of the fixed station 213 (fixed station #3) is represented by (x₃, y₃, z₃).

Each fixed station transmits a broadcasting signal including its own position information, its own identification information, and the like, and the mobile station 100 can recognize, based on the received broadcasting signal, information of the fixed station capable of communicating with the mobile station 100. The mobile station 100 calculates a propagation time required for wireless communication based on the transmission and reception timing of the UWB signal between the mobile station 100 and the recognized fixed station, and obtains a distance measurement result between the mobile station 100 and the recognized fixed station.

When the UWB signal is transmitted and received between the mobile station 100 and each fixed station, in a case where there is an object that reflects radio waves, such as a wall, as illustrated in FIG. 1, not only a direct wave 231 but also a reflected wave 232 is received on the reception side. In this case, the waveform of the received UWB signal is distorted.

FIG. 2 is a diagram illustrating an example of waveform distortion that occurs in a multipath environment. As illustrated in FIG. 2, in the multipath environment, a reception waveform 240 detected on the reception side is distorted as a result of combining a waveform 241 of the direct wave 231 and a waveform 242 of the reflected wave 232. The reception waveform 240 distorted as illustrated in FIG. 2 results in a signal waveform shifted backward in time as compared with the waveform 241 of the direct wave 231, and thus, the distance measurement result based on the reception waveform 240 tends to indicate a greater distance. That is, an error becomes larger. When the accuracy of the distance measurement result decreases in this manner, the accuracy of the estimation of the position of the mobile station 100 based on the distance measurement result also decreases.

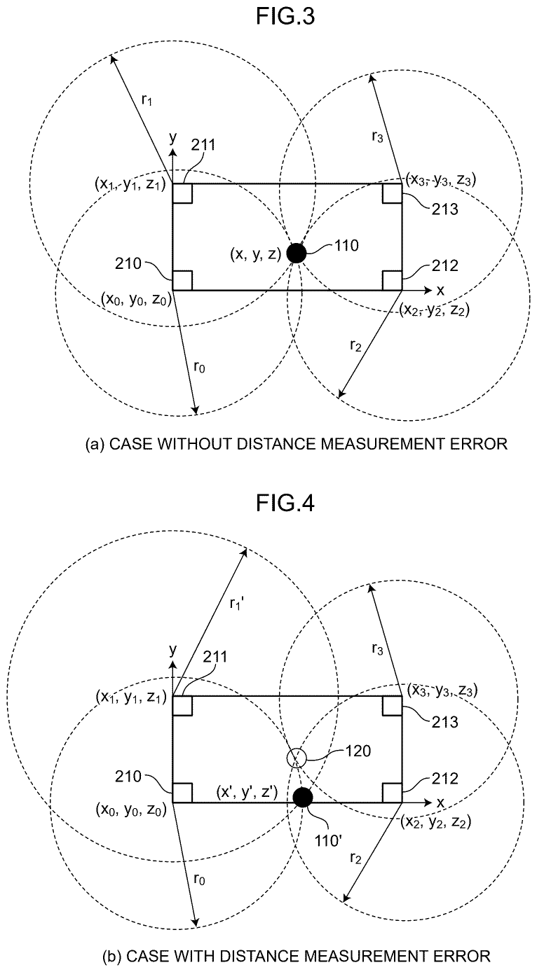

Here, with reference to FIGS. 3 and 4, a description will be given of examples of cases with and without a decrease in the accuracy of the distance measurement result. FIG. 3 is a diagram illustrating a first example of the distance measurement result and the position estimation result. Specifically, FIG. 3 illustrates an example of a relationship between the distance measurement result in a case without a decrease in the accuracy of the distance measurement result and without a distance measurement error and the position estimation result of the mobile station 100. FIG. 4 is a diagram illustrating a second example of the distance measurement result and the position estimation result. Specifically, FIG. 4 illustrates an example of a relationship between the distance measurement result in a case with a decrease in the accuracy of the distance measurement result and with a distance measurement error and the position estimation result of the mobile station 100.

In the example of “(a) case without distance measurement error” illustrated in FIG. 3, the distance measurement result between the mobile station 100 and the fixed station 210 is represented by r₀, the distance measurement result between the mobile station 100 and the fixed station 211 is represented by r₁, the distance measurement result between the mobile station 100 and the fixed station 212 is represented by r₂, and the distance measurement result between the mobile station 100 and the fixed station 213 is represented by r₃. A black circle indicates a position estimation result 110 and coincides with an actual position of the mobile station 100.

In the example of “(b) case with distance measurement error” illustrated in FIG. 4, an error is included in the distance measurement result between the mobile station 100 and the fixed station 211 due to an influence of a reflected wave or the like, and this distance measurement result is represented by r₁′. No error is included in the respective distance measurement results between the mobile station 100 and the other fixed stations (fixed stations 210, 212, and 213), and the respective distance measurement results are represented by r₀, r₂, r₃ as in FIG. 3. Assume that the distance measurement result r₁′ is greater than the distance measurement result r₁ of the example illustrated in FIG. 3 (r₁′>r₁). A white circle indicates an actual position 120 of the mobile station 100, and a black circle indicates a position estimation result 110′. As illustrated in FIG. 4, the case with the distance measurement error causes an error in the position estimation result.

In the first embodiment, a description will be given of a position estimation apparatus capable of reducing a decrease in the accuracy of the estimation of the position even in such a case with a decrease in accuracy of a distance measurement result due to an influence of a reflected wave.

First, based on the examples illustrated in FIGS. 3 and 4, a description will be given of the principle of a position estimation method used in a position estimation apparatus 1 according to the first embodiment.

In the example of FIG. 3, the mobile station 100 can communicate with the fixed stations 210, 211, 212, and 213 in an ideal state of radio wave propagation, and an intersection of four circles respectively having the distance measurement results r₀, r₁, r₂, and r₃ as their radii is a position estimation result. As an algorithm for this position estimation, for example, calculation is performed based on the least squares method. On the other hand, in the example of FIG. 4, that is, in a case where the radio wave propagation is not in an ideal state due to the influence of the reflected wave or the like, an error occurs in the distance measurement results. Since the error is included in the distance measurement results, the distance measurement results between the individual fixed stations 210, 211, 212, and 213 and the mobile station 100 are represented by r₀, r₁′, r₂, and r₃, respectively, where r₁′>r₁. When the position of the mobile station 100 is estimated by the least squares method using the distance measurement results including an error such as r₁′, an intersection of four circles having the respective distance measurement results as their radii cannot be obtained. In this case, a position at which a square value of the error is minimum is estimated, and an estimated position is indicated as the position estimation result 110′. That is, a position estimation error occurs with respect to the actual position 120 of the mobile station 100 indicated by the white circle. Thus, the position estimation apparatus 1 according to the present embodiment repeatedly performs position estimation calculation of the mobile station 100 such that among the distance measurement results between the fixed stations and the mobile station 100, the influence of a distance measurement result, which is affected by a reflected wave or the like, causing a large distance measurement error, is reduced. Specifically, the position estimation apparatus 1 repeatedly performs position estimation calculation using the least squares method, in which weighting inversely proportional to the square of the distance measurement error is performed, for the distance measurement results between the individual fixed stations and the mobile station 100, thus obtaining a position estimation result.

Hereinafter, details of the position estimation apparatus 1 according to the first embodiment will be described.

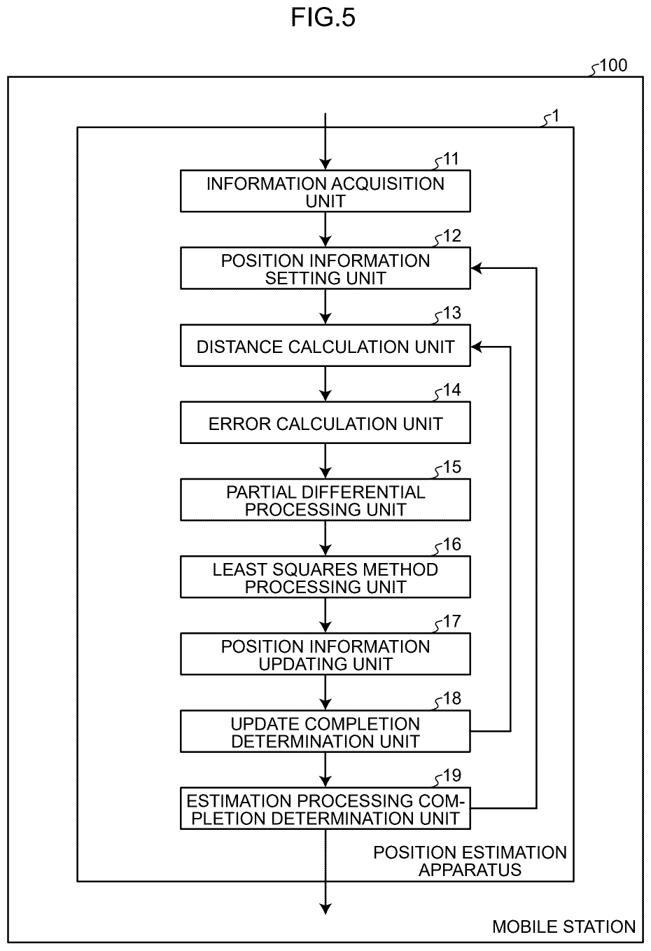

FIG. 5 is a diagram illustrating an exemplary configuration of the position estimation apparatus 1 according to the first embodiment. As illustrated in FIG. 5, in the present embodiment, assume that the position estimation apparatus 1 is provided in the mobile station 100. Note that the position estimation apparatus 1 may be provided as a separate apparatus outside the mobile station 100.

The position estimation apparatus 1 includes an information acquisition unit 11, a position information setting unit 12, a distance calculation unit 13, an error calculation unit 14, a partial differential processing unit 15, a least squares method processing unit 16, a position information updating unit 17, an update completion determination unit 18, and an estimation processing completion determination unit 19.

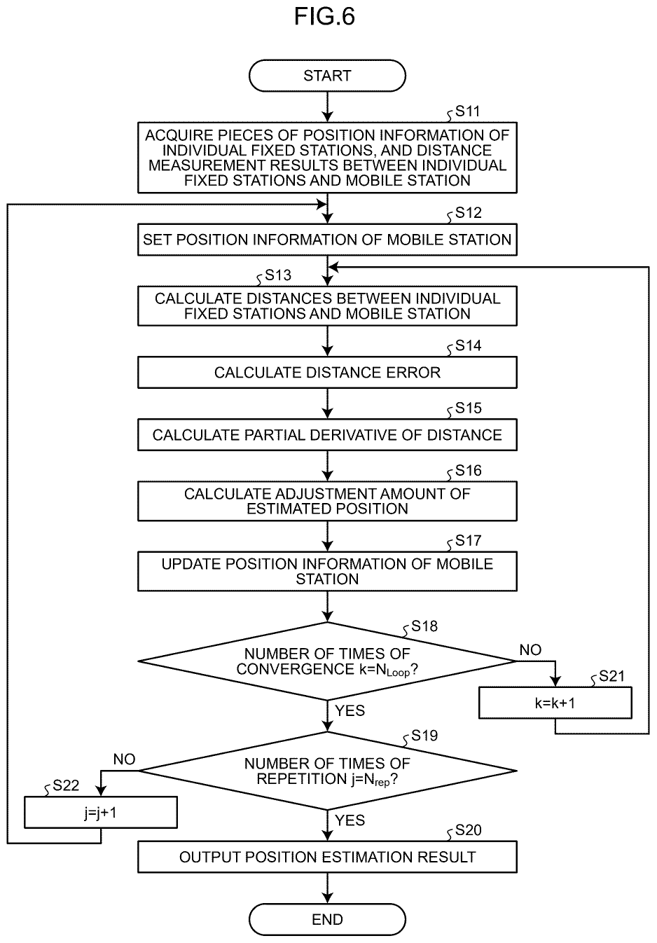

FIG. 6 is a flowchart illustrating an example of an operation in which the position estimation apparatus 1 according to the first embodiment estimates a position of the mobile station 100.

With reference to FIGS. 5 and 6, a detailed operation of the position estimation apparatus 1 will be described for each component. Here, as an example, as illustrated in FIG. 1, a description will be given on the assumption that the number of fixed stations included in the position estimation system 200 is set to N=4 and the position information of the mobile station 100 is coordinates (x,y,z). Each of the fixed stations included in the position estimation system 200 can transmit and receive a UWB signal to and from the mobile station 100, and, from the perspective of the mobile station 100, is a fixed station whose distance to the mobile station 100 can be measured.

In the position estimation apparatus 1, the information acquisition unit 11 acquires pieces of position information of the individual fixed stations and distance measurement results between the individual fixed stations and the mobile station 100 (step S11). For example, the information acquisition unit 11 periodically acquires the pieces of position information and the distance measurement results at a predetermined cycle.

The pieces of position information of the individual fixed stations are acquired by receiving broadcasting signals transmitted from the individual fixed stations and analyzing the received broadcasting signals. The broadcasting signals are analyzed, for example, by a transmission-reception processing unit (not illustrated) of the mobile station 100. Note that the information acquisition unit 11 may analyze the broadcasting signals.

The distance measurement results between the individual fixed stations and the mobile station 100 are derived based on results of wireless communication between the individual fixed stations and the mobile station 100. Specifically, the mobile station 100 transmits and receives a UWB signal to and from each fixed station, calculates a propagation time required for wireless communication based on a transmission and reception timing of each UWB signal, and obtains a distance measurement result indicating a distance to each fixed station based on the calculated propagation time. The processing for obtaining the distance measurement results is performed, for example, by the transmission-reception processing unit of the mobile station 100. Note that the aforementioned pieces of processing from the calculation of the propagation time to the obtaining of the distance measurement result may be performed by the information acquisition unit 11. The aforementioned calculation of the propagation time may be performed by the mobile station 100, and the aforementioned processing of calculating the distance measurement result based on the propagation time may be performed by the information acquisition unit 11.

The information acquisition unit 11 may acquire, at the same time or at different timings, the pieces of position information of the individual fixed stations and the distance measurement results between the individual fixed stations and the mobile station 100. For example, the information acquisition unit 11 may acquire the distance measurement results between the individual fixed stations and the mobile station 100 every time the mobile station 100 receives the broadcasting signals transmitted from the individual fixed stations.

The position information setting unit 12 sets the position information of the mobile station 100 (step S12). Specifically, the position information setting unit 12 sets position information (x₍ₖ₎,y₍ₖ₎,z₍ₖ₎) for performing estimation of the position of the mobile station 100. Here, k represents the number of times of convergence for sequential approximation, where k=1, 2, . . . , N_{Loop}. The position information (x₍₁₎,y₍₁₎,z₍₁₎) of the mobile station 100 in the case of k=1 does not necessarily need to be accurate. In step S12, which is executed first after step S11 is executed, that is, in an initial stage where the position of the mobile station 100 has not yet been calculated, the coordinates around the plurality of fixed stations may be set as an initial value of the position information of the mobile station 100. Additionally, in step S12 (step S12 for the first time), which is executed first after step S11 is executed, the position information setting unit 12 sets the position information and simultaneously sets the number of times of repetition j to j=1.

The distance calculation unit 13 calculates the distances between the individual fixed stations and the mobile station 100 (step S13). In step S13, the distance calculation unit 13 calculates the distances between the individual fixed stations and the mobile station 100 using the pieces of position information of the individual fixed stations acquired by the information acquisition unit 11 in step S11, and the position information set by the position information setting unit 12 in step S12 or position information updated by the position information updating unit 17, which will be described later. Specifically, in step S13 (step S13 for the first time), which is executed first after step S12 is executed, the distance calculation unit 13 calculates the distances between the individual fixed stations and the mobile station 100 using the pieces of position information of the individual fixed stations and the position information set by the position information setting unit 12. In subsequent step S13 (step S13 for second and subsequent times), the distance calculation unit 13 calculates the distances between the individual fixed stations and the mobile station 100 using the pieces of position information of the individual fixed stations and the position information updated by the position information updating unit 17. Note that, in step S13, which is executed first after step S12 is executed, the distance calculation unit 13 sets the number of times of convergence k to k=1 and then calculates the distances between the individual fixed stations and the mobile station 100.

When the pieces of position information of the individual fixed stations used by the distance calculation unit 13 to calculate the distances are represented by (xᵢ,yᵢ,zᵢ) and the position information of the mobile station 100 is represented by (x₍ₖ₎,y₍ₖ₎,z₍ₖ₎), the distance calculation unit 13 calculates a distance rᵢ₍ₖ₎ between the i-th fixed station and the mobile station 100 in accordance with Formula (1) below. Note that, in the following description, the distance rᵢ₍ₖ₎ calculated by the distance calculation unit 13 may also be referred to as an estimated distance rᵢ(k).

$$\begin{matrix}Formula 1 & \\ {r}_{i ( k )} = \sqrt{{( {x}_{i} - {x}_{( k )} )}^{2} + {( {y}_{i} - {y}_{( k )} )}^{2} + {( {z}_{i} - {z}_{( k )} )}^{2}} & ( 1 )\end{matrix}$$

In Formula (1), i=0, 1, . . . , N−1. Here, N represents the number of fixed stations whose distances to the mobile station 100 can be measured, where N=4 in the case of the configuration illustrated in FIG. 1.

Note that, when receiving, through the update completion determination unit 18, the position information of the mobile station 100 updated by the position information updating unit 17, which will be described later, the distance calculation unit 13 calculates the estimated distance again using the received position information.

The error calculation unit 14 calculates a distance error (step S14). Specifically, the error calculation unit 14 calculates, in accordance with Formula (2) below, a distance error Δrᵢ₍ₖ₎, which is an error between the distance rᵢ between the i-th fixed station and the mobile station 100, which is included in the distance measurement results acquired by the information acquisition unit 11 in step S11, and the estimated distance rᵢ₍ₖ₎ calculated by the distance calculation unit 13.

$$\begin{matrix}Formula 2 & \\ Δ {r}_{i ( k )} = {r}_{i} - {r}_{i ( k )} & ( 2 )\end{matrix}$$

The partial differential processing unit 15 calculates a partial derivative of the distance rᵢ (step S15).

Here, there is a relationship expressed by Formula (3) below between the distance error Δrᵢ₍ₖ₎ calculated by the error calculation unit 14 and partial differential calculation of the estimated distance rᵢ₍ₖ₎.

$$\begin{matrix}Formula 3 & \\ Δ {r}_{i ( k )} = \frac{\partial {r}_{{i}_{( k )}}}{\partial x} \cdot Δ {x}_{( k )} + \frac{\partial {r}_{{i}_{( k )}}}{\partial y} \cdot Δ {y}_{( k )} + \frac{\partial {r}_{{i}_{( k )}}}{\partial z} \cdot Δ {z}_{( k )} & ( 3 )\end{matrix}$$

In Formula (3), Δx₍ₖ₎, Δy₍ₖ₎, and Δz₍ₖ₎ indicate respective errors between x, y, and z coordinates of the estimated position of the mobile station 100 and coordinates (actual x, y, and z coordinates) of an actual position of the mobile station 100.

From the N simultaneous equations derived from Formula (3), which indicate a relationship between the distance error Δrᵢ₍ₖ₎ and a partial differential calculation result of the estimated distance rᵢ₍ₖ₎ for each of the plurality of fixed stations #i (i=0, 1, . . . , N−1), it is possible to calculate an infinitesimal change in the position of the mobile station 100 as expressed by Formula (4) below. The infinitesimal change in the position of the mobile station 100 as expressed by Formula (4) below corresponds to an adjustment amount for each of the coordinates of the estimated position of the mobile station 100. In the following description, the “adjustment amount for each of the coordinates of the estimated position” is referred to as the “adjustment amount of the estimated position”.

$$\begin{matrix}Formula 4 & \\ {Δ {p}_{( k )}}^{⟶} = [ Δ {x}_{( k )} , Δ {y}_{( k )} , Δ {z}_{( k )} ] & ( 4 )\end{matrix}$$

The partial differential processing unit 15 performs the partial differential calculation of the estimated distance rᵢ₍ₖ₎ in accordance with Formula (5) below.

$$\begin{matrix}Formula 5 & \\ \begin{matrix}\frac{\partial {r}_{{i}_{( k )}}}{\partial x} = - ( {x}_{i} - {x}_{( k )} ) / {r}_{i} \\ \frac{\partial {r}_{{i}_{( k )}}}{\partial y} = - ( {y}_{i} - {y}_{( k )} ) / {r}_{i} \\ \frac{\partial {r}_{{i}_{( k )}}}{\partial z} = - ( {z}_{i} - {z}_{( k )} ) / {r}_{i}\end{matrix} & ( 5 )\end{matrix}$$

Here, regarding Formula (3) above, in a case where the distance measurement can be performed between the N fixed stations and the mobile station 100, the matrix representation of the partial differential calculation of the estimated distance rᵢ₍ₖ₎ is given by Formula (6) below.

$$\begin{matrix}Formula 6 & \\ {G}_{( k )} = [ \begin{matrix}\frac{\partial {r}_{{0}_{( k )}}}{\partial x} & \frac{\partial {r}_{{0}_{( k )}}}{\partial y} & \frac{\partial {r}_{{0}_{( k )}}}{\partial z} \\ \frac{\partial {r}_{{1}_{( k )}}}{\partial x} & \frac{\partial {r}_{{1}_{( k )}}}{\partial y} & \frac{\partial {r}_{{1}_{( k )}}}{\partial z} \\ ⋮ & ⋮ & ⋮ \\ \frac{\partial {r}_{N - {1}_{( k )}}}{\partial x} & \frac{\partial {r}_{N - {1}_{( k )}}}{\partial y} & \frac{\partial {r}_{N - {1}_{( k )}}}{\partial z}\end{matrix} ] & ( 6 )\end{matrix}$$

Additionally, in Formula (3) above, when the distance error Δrᵢ₍ₖ₎ is expressed as a vector representation for the number of fixed stations, Formula (7) below is obtained.

$$\begin{matrix}Formula 7 & \\ {Δ {r}_{( k )}}^{⟶} = {[ Δ {r}_{{0}_{( k )}} , Δ {r}_{{1}_{( k )}} , … , Δ {r}_{N - {1}_{( k )}} ]}^{T} & ( 7 )\end{matrix}$$

After calculating the partial derivative of the estimated distance rᵢ₍ₖ₎, the partial differential processing unit 15 outputs, to the least squares method processing unit 16, the matrix representation of the partial differential calculation of the estimated distance rᵢ₍ₖ₎ expressed by Formula (6) and the vector representation of the distance error Δrᵢ₍ₖ₎ for the number of fixed stations expressed by Formula (7).

The least squares method processing unit 16 calculates the adjustment amount of the estimated position using the least squares method (step S16).

In step S16, when j=0, the least squares method processing unit 16, which corresponds to an estimated position adjustment amount calculation unit, calculates the adjustment amount of the estimated position of the mobile station 100 by an unweighted least squares method. When the vector representation of an adjustment amount Δp₍ₖ₎ of the estimated position of the mobile station 100 is expressed by Formula (8) below, the least squares method processing unit 16 calculates the adjustment amount Δp₍ₖ₎ of the estimated position of the mobile station 100 by using the least squares method using the vector representation of a distance error Δr₍ₖ₎ expressed by Formula (7). In this case, the vector representation of the adjustment amount Δp₍ₖ₎ of the estimated position calculated by the least squares method processing unit 16 is given by Formula (9) below.

$$\begin{matrix}Formula 8 & \\ {Δ {p}_{( k )}}^{⟶} = {[ Δ {x}_{( k )} , Δ {y}_{( k )} , Δ {z}_{( k )} ]}^{T} & ( 8 )\end{matrix}$$

$$\begin{matrix}Formula 9 & \\ {Δ {p}_{( k )}}^{⟶} = {[ {G}_{( k )}^{T} {G}_{( k )} ]}^{- 1} {G}_{( k )}^{T} {Δ {r}_{( k )}}^{⟶} & ( 9 )\end{matrix}$$

Furthermore, when 1<j, the least squares method processing unit 16 calculates the adjustment amount Δp₍ₖ₎ of the estimated position of the mobile station 100 by a weighted least squares method. In this case, the vector representation of the adjustment amount Δp₍ₖ₎ of the estimated position calculated by the least squares method processing unit 16 is given by Formula (10) below.

$$\begin{matrix}Formula 10 & \\ {Δ {p}_{( k )}}^{⟶} = {( {G}_{( k )}^{T} {WG}_{( k )} )}^{- 1} {G}_{( k )}^{T} W {Δ {r}_{( k )}}^{⟶} & ( 10 )\end{matrix}$$

In Formula (10), W is a diagonal matrix for performing weighting and is given by Formula (11) below.

$$\begin{matrix}Formula 11 & \\ W = diag ( {W}_{0} , {W}_{1} , ⋯ , {W}_{N - 1} ) & ( 11 )\end{matrix}$$

A weighting coefficient, which is an element of the diagonal matrix in Formula (11), uses the distance measurement estimation error (variance σ) as Wᵢ=1/σᵢ² (i=0, 1, . . . , N−1). Specifically, a weighting coefficient Wᵢ is expressed by Formula (12) below, which is inversely proportion to the square of the distance measurement error, using the distance error Δrᵢ₍ₖ₎, expressed by Formula (2), estimated for the distance between the i-th fixed station and the mobile station 100 at the number of times of convergence k.

$$\begin{matrix}Formula 12 & \\ {W}_{i} = 1 / {( Δ {{r}_{i}}_{( k )} )}^{2} & ( 12 )\end{matrix}$$

However, the weighting coefficient Wᵢ expressed in Formula (12) approaches infinity when the distance error Δrᵢ₍ₖ₎ approaches zero, and thus, the contribution of a certain fixed station may become excessively high. In this case, the accuracy of the estimation of the position decreases, and the calculation result of the least squares method becomes unstable in terms of numerical calculation.

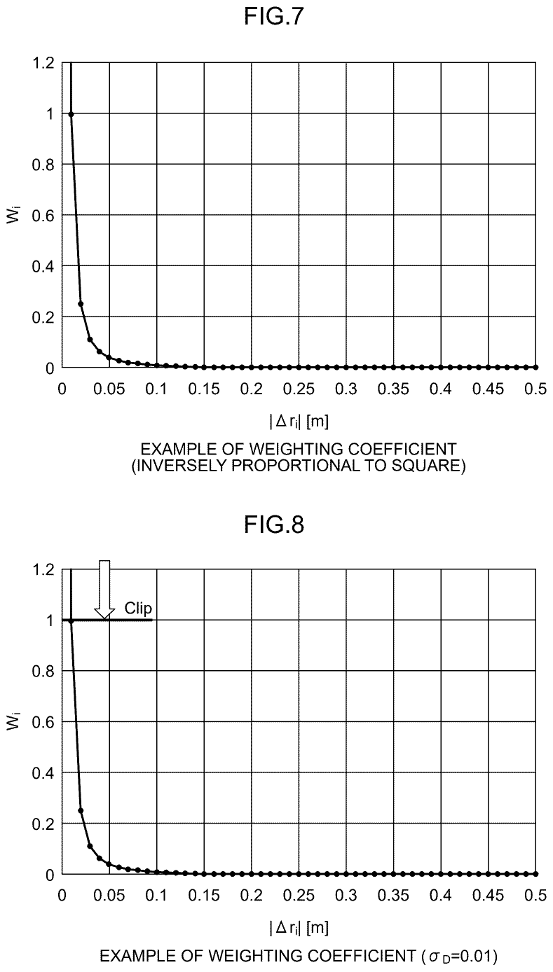

FIG. 7 is a diagram illustrating a relationship between the distance error Δrᵢ₍ₖ₎ and the weighting coefficient Wᵢ in the position estimation apparatus 1 according to the first embodiment. As illustrated in FIG. 7, when the distance error Δrᵢ₍ₖ₎ approaches zero, the weighting coefficient Wᵢ becomes markedly large. Thus, in the position estimation apparatus 1 according to the present embodiment, as illustrated in FIG. 8, clip processing is applied to avoid the weighting coefficient Wᵢ becoming markedly large when the distance error Δrᵢ₍ₖ₎ approaches zero. Incidentally, FIG. 8 is a diagram for describing the clip processing used in the position estimation apparatus 1 according to the first embodiment. FIG. 8 illustrates, as an example, a relationship between the distance error Δrᵢ₍ₖ₎ and the weighting coefficient Wᵢ when the clip processing is performed with the upper limit of the weighting coefficient Wᵢ set to 1. Note that the upper limit of the weighting coefficient Wᵢ does not necessarily need to be set to 1. Any value may be set in accordance with the accuracy of the estimation of the position, and stability in terms of numerical calculation.

The calculation result from the least squares method processing unit 16, that is, the vector of the adjustment amount of the estimated position of the mobile station 100 as expressed by Formula (9) or Formula (10) is input to the position information updating unit 17.

The position information updating unit 17 updates the position information of the mobile station 100 (step S17). Specifically, the position information updating unit 17 uses the vector of the adjustment amount of the estimated position of the position of the mobile station 100 received from the least squares method processing unit 16, and updates the position information (x₍ₖ₎, y₍ₖ₎, z₍ₖ₎) indicating the estimated position of the mobile station 100 in accordance with Formula (13) below.

$$\begin{matrix}Formula 13 & \\ \begin{matrix}{x}_{( k + 1 )} = {x}_{( k )} + Δ {x}_{( k )} \\ {y}_{( k + 1 )} = {y}_{( k )} + Δ {y}_{( k )} \\ {z}_{( k + 1 )} = {{z}_{( k )}}_{} + Δ {z}_{( k )}\end{matrix} & ( 13 )\end{matrix}$$

The position information updating unit 17 outputs the updated position information of the mobile station 100 to the update completion determination unit 18.

When receiving the position information of the mobile station 100 from the position information updating unit 17, the update completion determination unit 18 determines whether to complete estimated position update processing, which is processing of updating the position information of the mobile station 100, that is, whether the number of times of convergence k is N_{Loop} (step S18).

When the number of times of convergence k is k=N_{Loop} (step S18: Yes), the update completion determination unit 18 determines that the update of the position information is complete, and outputs, to the estimation processing completion determination unit 19, the position information (x₍ₖ₎,y₍ₖ₎,z₍ₖ₎), (k=N_{Loop}+1) of the mobile station 100 received from the position information updating unit 17. Accordingly, the estimation processing completion determination unit 19 executes step S19, which will be described later.

When the number of times of convergence k is k<N_{Loop} (step S18: No), the update completion determination unit 18 determines to continue the update of the position information, and outputs, to the distance calculation unit 13, the position information (x₍ₖ₎,y₍ₖ₎,z₍ₖ₎), (k=1, 2, . . . , N_{Loop}) of the mobile station 100 received from the position information updating unit 17 as the updated position information. At this time, the update completion determination unit 18 increments the number of times of convergence k (step S21). When receiving the updated position information of the mobile station 100 from the update completion determination unit 18, the distance calculation unit 13 recalculates the distances between the individual fixed stations and the mobile station 100 using the received position information (step S13). Thereafter, the pieces of processing of steps S13 to S18 and S21 described above are repeated in the position estimation apparatus 1 until the number of times of convergence k becomes k=N_{Loop}.

When receiving the position information of the mobile station 100 from the update completion determination unit 18, the estimation processing completion determination unit 19 determines whether to complete the position estimation processing of the mobile station 100, that is, whether the number of times of repetition j is Nᵣₑₚ (step S19).

When the number of times of repetition j is j=Nᵣₑₚ(step S19: Yes), the estimation processing completion determination unit 19 determines that the position estimation processing is complete, and outputs the position information (x₍ₖ₎,y₍ₖ₎,z₍ₖ₎), (k=N_{Loop}+1) of the mobile station 100 received from the update completion determination unit 18 as a position estimation result (step S20).

When the number of times of repetition j is j<Nᵣₑₚ (step S19: No), the estimation processing completion determination unit 19 determines to continue the position estimation processing, and outputs, to the position information setting unit 12, the position information of the mobile station 100 received from the update completion determination unit 18. At this time, the estimation processing completion determination unit 19 increments the number of times of repetition j (step S22). When receiving the position information of the mobile station 100 from the estimation processing completion determination unit 19, the position information setting unit 12 sets the received position information (step S12). Specifically, the position information setting unit 12 uses the received position information (x₍ₖ₎, y₍ₖ₎, z₍ₖ₎), (k=N_{Loop}+1), to set the position information of the mobile station 100 corresponding to the number of times of repetition (j+1th) in accordance with Formula (14) below.

$$\begin{matrix}Formula 14 & \\ ( {x}_{( 1 )} {y}_{( 1 )} , {z}_{( 1 )} ) = ( {x}_{( {N}_{Loop} + 1 )} , {y}_{( {N}_{Loop} + 1 )} , {z}_{( {N}_{Loop} + 1 )} ) & ( 14 )\end{matrix}$$

Thereafter, the pieces of processing of steps S12 to S19, S21, and S22 described above are repeated in the position estimation apparatus 1 until the number of times of repetition j becomes j=Nᵣₑₚ.

As described above, the position estimation apparatus 1 according to the first embodiment repeatedly executes the update processing using the least squares method, in which weighting inversely proportional to the square of the distance error is performed, for the estimated position of the mobile station 100 such that among the distance measurement results between the plurality of fixed stations and the mobile station 100, the influence of a distance measurement result, which is affected by a reflected wave or the like, causing a large distance measurement error, is reduced. This makes it possible to prevent a decrease in accuracy of the estimation of the position. Additionally, it is possible to improve the accuracy of the estimation of the position of the mobile station 100 by repeatedly using the same distance measurement result.

### Second Embodiment

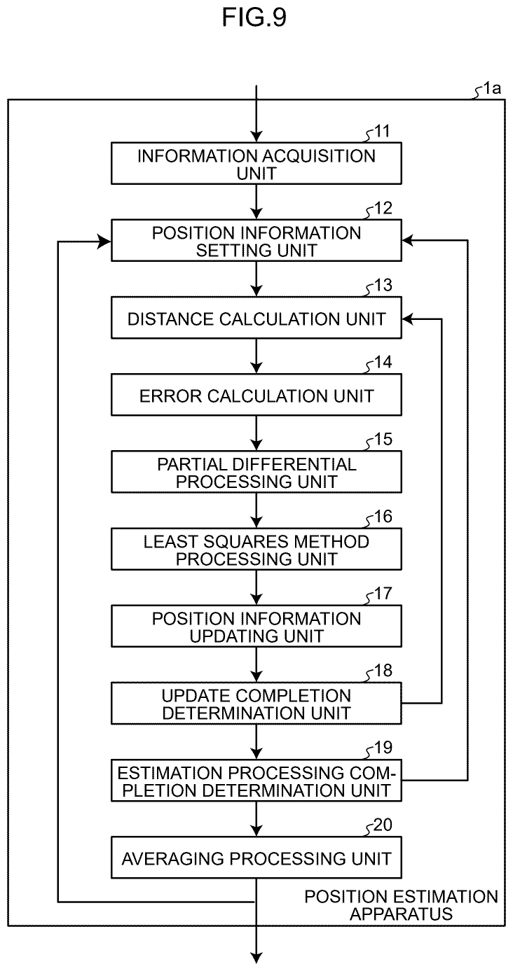

FIG. 9 is a diagram illustrating an exemplary configuration of a position estimation apparatus 1a according to a second embodiment. Note that assume that the position estimation apparatus 1a is provided in the mobile station 100 similarly to the position estimation apparatus 1 according to the first embodiment, but the mobile station 100 is not illustrated in FIG. 9.

The position estimation apparatus 1a has a configuration in which an averaging processing unit 20 is added to the position estimation apparatus 1 according to the first embodiment. The components other than the averaging processing unit 20 of the position estimation apparatus 1a are the same as the components, which are denoted by the identical reference signs, of the position estimation apparatus 1 according to the first embodiment. Thus, the description of the components other than the averaging processing unit 20 will be omitted.

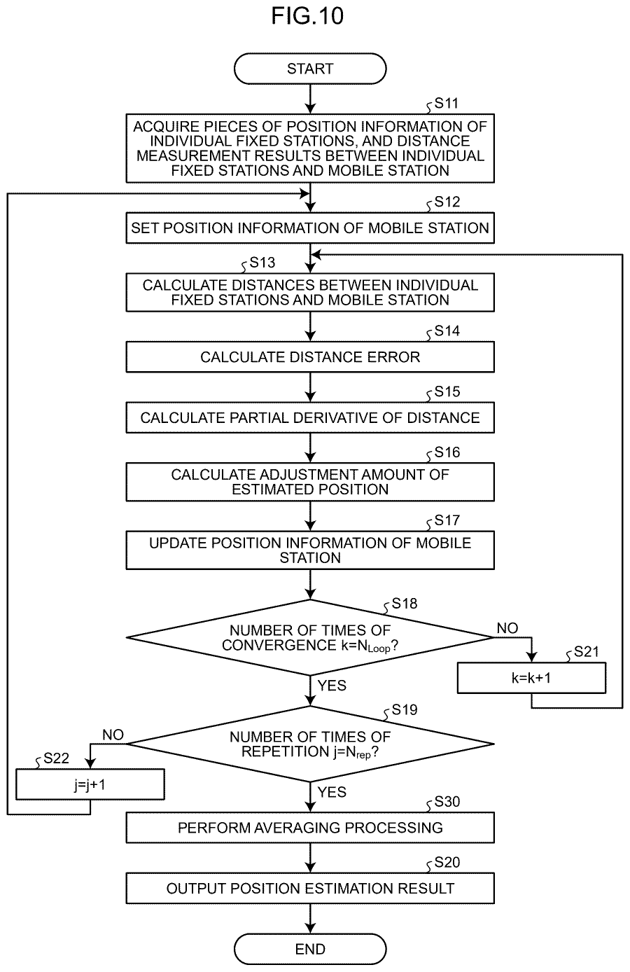

FIG. 10 is a flowchart illustrating an example of an operation in which the position estimation apparatus 1a according to the second embodiment estimates a position of the mobile station 100. The flowchart illustrated in FIG. 10 is obtained by adding step S30 to the flowchart of FIG. 6 illustrating the operation in which the position estimation apparatus 1 according to the first embodiment performs position estimation. The pieces of processing of the steps other than step S30 of the position estimation apparatus 1a according to the second embodiment are similar to the pieces of processing, which are assigned with the identical step numbers, of the position estimation apparatus 1 according to the first embodiment. Thus, the description of the pieces of processing of the steps other than step S30 will be omitted. Note that the processing of step S30 is executed by the averaging processing unit 20.

When the processing result in step S19 in FIG. 10 is “Yes”, the estimated position of the mobile station 100 output by the estimation processing completion determination unit 19 is input to the averaging processing unit 20 of the position estimation apparatus 1a. When receiving the estimated position of the mobile station 100 from the estimation processing completion determination unit 19, the averaging processing unit 20 performs averaging processing on the received estimated position (step S30). That is, the averaging processing unit 20 executes the averaging processing on the estimated position of the mobile station 100 so as to reduce a decrease in the accuracy of the estimation of the position of the mobile station 100 due to the distance measurement errors between the plurality of fixed stations and the mobile station 100.

The estimated position obtained through the execution of the averaging processing by the averaging processing unit 20 is output to the outside of the position estimation apparatus 1a as a position estimation result of the mobile station 100, and is also output to the position information setting unit 12. When receiving the position estimation result from the averaging processing unit 20, the position information setting unit 12 holds the received position estimation result, and sets the held position estimation result as the position information of the mobile station 100 in step S12 for the first time of the next position estimation operation.

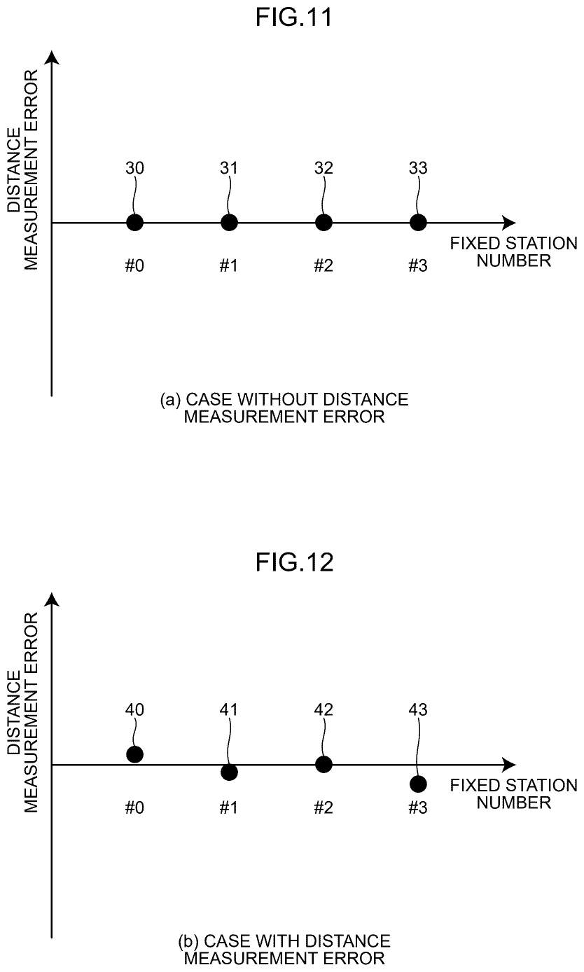

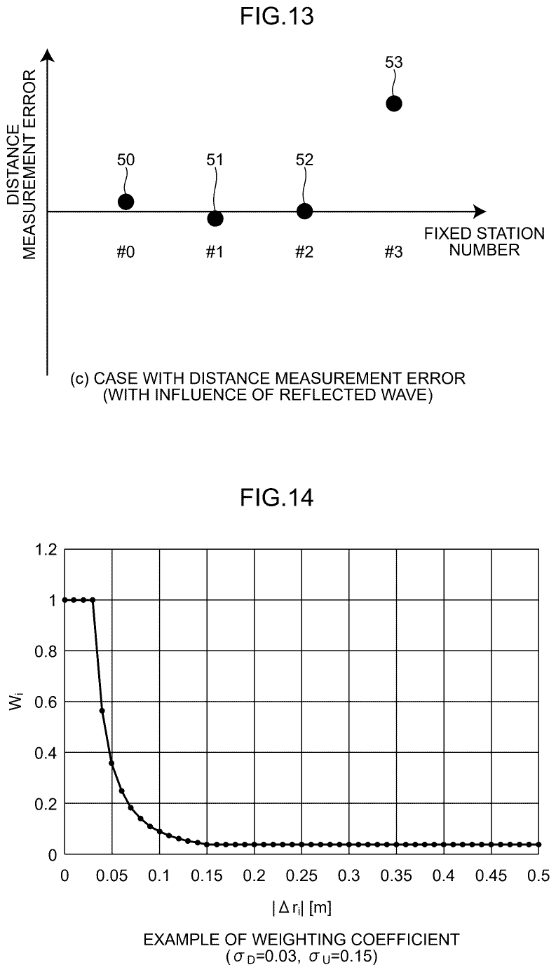

FIG. 11 is a diagram illustrating a first example of distance measurement errors between the fixed stations and the mobile station 100. FIG. 12 is a diagram illustrating a second example of distance measurement errors between the fixed stations and the mobile station 100. FIG. 13 is a diagram illustrating a third example of distance measurement errors between the fixed stations and the mobile station 100. FIGS. 11 to 13 each illustrate an example of distance measurement errors between the four individual fixed stations #0 to #3 and the mobile station 100. Specifically, FIG. 11 illustrates a case where no distance measurement error occurs between the individual fixed stations #0 to #3 and the mobile station 100. FIG. 12 illustrates a case where distance measurement errors exhibiting slight variations occur between the individual fixed stations #0 to #3 and the mobile station 100. FIG. 13 illustrates a case where a large distance measurement error due to an influence of a reflected wave or the like occurs between the individual fixed stations #0 to #3 and the mobile station 100.

In the first example illustrated in FIG. 11, distance measurement errors 30, 31, 32, and 33 between the individual fixed stations #0 to #3 and the mobile station 100 are all zero. Additionally, in the second example illustrated in FIG. 12, there are slight variations among distance measurement errors 40, 41, 42, and 43 between the individual fixed stations #0 to #3 and the mobile station 100. Additionally, in the third example illustrated in FIG. 13, there are variations among distance measurement errors 50, 51, 52, and 53 between the individual fixed stations #0 to #3 and the mobile station 100, and particularly, the distance measurement result between the fixed station #3 and the mobile station 100 includes the large distance measurement error 53 due to the influence of the reflected wave.

As in the second example illustrated in FIG. 12 and the third example illustrated in FIG. 13, variations in the distance measurement errors among the fixed stations may possibly cause a minute error in the calculation result in the least squares method processing unit 16, resultantly causing an error also in the position estimation result of the mobile station 100. Additionally, since the position estimation result, which is the output of the estimation processing completion determination unit 19, is set as an initial value (x₍₁₎,y₍₁₎,z₍₁₎) of the position information of the mobile station 100 to be set by the position information setting unit 12 in the next position estimation operation, in a case where there is a large variation in the distance measurement errors among the fixed stations, it may become difficult to improve the accuracy of the estimation of the position, for example, it may become necessary to increase the number of times of repetition j in order to reduce an increase in the number of times of convergence k for the position estimation or the contribution of the distance measurement result affected by the reflected wave to the position estimation. In order to solve such problems, the position estimation apparatus 1a according to the second embodiment includes the averaging processing unit 20. The averaging processing unit 20 averages the estimated positions of the mobile station 100, which are output by the estimation processing completion determination unit 19, using a Finite Impulse Response (FIR) filter, an Infinite Impulse Response (IIR) filter, or the like. Each of the estimated positions is obtained each time the information acquisition unit 11 newly acquires the distance measurement results obtained between the fixed stations and the mobile station 100. This can improve the accuracy of the estimation of the position.

As described above, the position estimation apparatus 1a according to the second embodiment includes the averaging processing unit 20 that averages position estimation results obtained by executing the processing similar to that of the position estimation apparatus 1 according to the first embodiment. Consequently, even in a case where there are variations in the distance measurement errors among the fixed stations whose distances to the mobile station 100 are to be measured, the influence due to the variations can be reduced, thus improving the accuracy of the estimation of the position of the mobile station 100. Additionally, the number of times of convergence and the number of times of repetition for position estimation can be reduced. Additionally, it is possible to accurately reduce the contribution of the distance measurement result affected by the reflected wave to the position estimation, thus improving the accuracy of the estimation of the position of the mobile station 100.

### Third Embodiment

Next, a third embodiment will be described. The position estimation apparatus according to the third embodiment has the same configuration as the position estimation apparatus 1 according to the first embodiment (see FIG. 5). However, the weighting coefficient Wᵢ used in weighted least squares method processing by the least squares method processing unit 16 is different from that of the first embodiment. Thus, in the present embodiment, a description will be given of only the least squares method processing unit 16 and the weighting coefficients Wᵢ used by the least squares method processing unit 16, and the description of the other components common to the first embodiment will be omitted.

The weighting coefficient Wᵢ used in the third embodiment will be described with reference to FIG. 14. Note that FIG. 14 is a diagram illustrating an example of a weighting coefficient used in least squares method processing in a position estimation apparatus according to the third embodiment. FIG. 14 illustrates a correspondence relationship between the distance measurement errors and the weighting coefficient. In FIG. 14, the horizontal axis represents an absolute value of the distance measurement errors, and the vertical axis represents the weighting coefficient. σ_{D} is a lower limit value of an absolute value of a distance error Δrᵢ, and in FIG. 14, as an example, σ_{D}=0.03 is set. Additionally, σ_{U} is an upper limit value of the absolute value of the distance error Δrᵢ, and in FIG. 14, as an example, σ_{U}=0.15 is set.

As illustrated in FIG. 14, in a case where the distance measurement errors between the fixed stations and the mobile station 100 are sufficiently small, the position estimation apparatus 1 according to the third embodiment estimates the position of the mobile station 100 using a weighting coefficient Wᵢ of a magnitude that does not interfere with numerical calculation.

The weighting coefficient Wᵢ used by the least squares method processing unit 16 of the position estimation apparatus 1 according to the third embodiment is given by Formula (15) below. In Formula (15) below, i represents a fixed station number, where i=0, 1, . . . , N−1.

$$\begin{matrix}Formula 15 & \\ {W}_{i} = \{ \begin{matrix}1 , & {( Δ {r}_{{i}_{( k )}} )}^{2} < {σ}_{D}^{2} \\ {σ}_{D}^{2} / {( Δ {r}_{{i}_{( k )}} )}^{2} , & {σ}_{D}^{2} \leq {( Δ {r}_{{i}_{( k )}} )}^{2} \leq {σ}_{U}^{2} \\ {σ}_{D}^{2} / {σ}_{U}^{2} , & {( Δ {r}_{{i}_{( k )}} )}^{2} > {σ}_{U}^{2}\end{matrix} & ( 15 )\end{matrix}$$

In the weighting coefficient Wᵢ in Formula (12) above used in the position estimation apparatus 1 according to the first embodiment, the weighting coefficient Wᵢ becomes markedly large as the distance error Δrᵢ₍ₖ₎ approaches zero, and thus the clip processing is executed. On the other hand, in the weighting coefficient Wᵢ in Formula (15) used in the position estimation apparatus 1 according to the third embodiment, a lower limit value σ_{D}² of a square value ((Δrᵢ₍ₖ₎)²) of the distance error Δrᵢ₍ₖ₎ is set instead of the clip processing. Additionally, as (Δrᵢ₍ₖ₎)² increases, the weighting coefficient Wᵢ inversely proportional to the square rapidly decreases and approaches zero. In particular, when the position information of the mobile station 100 initially set by the position information setting unit 12 at the time of position estimation is greatly deviated from the original position of the mobile station 100, the distance error Δrᵢ₍ₖ₎ between the fixed station and the mobile station 100 tends to be large, and the value of the weighting coefficient Wᵢ is possibly smaller than the original value. This is equivalent to a decrease in the number of valid fixed stations that can be used for position estimation, and the accuracy of the estimation of the position may possibly decrease. Thus, an upper limit value σ_{U}² of (Δrᵢ₍ₖ₎)² is set such that the lower limit value of the weighting coefficient Wᵢ can be set.

As described above, in the position estimation apparatus 1 according to the third embodiment, the least squares method processing unit 16 sets the upper limit value and the lower limit value for the weighting coefficient Wᵢ used in the weighted least squares method processing. This setting can prevent the weighting coefficient Wᵢ used in the weighted least squares method processing from becoming markedly large in terms of numerical calculation, and reduce a decrease in the number of valid fixed stations that can be used for position estimation even in a case where the accuracy of the position information of the mobile station 100 set at the time of estimating the position of the mobile station 100 is low, thus preventing a decrease in the accuracy of position estimation.

### Fourth Embodiment

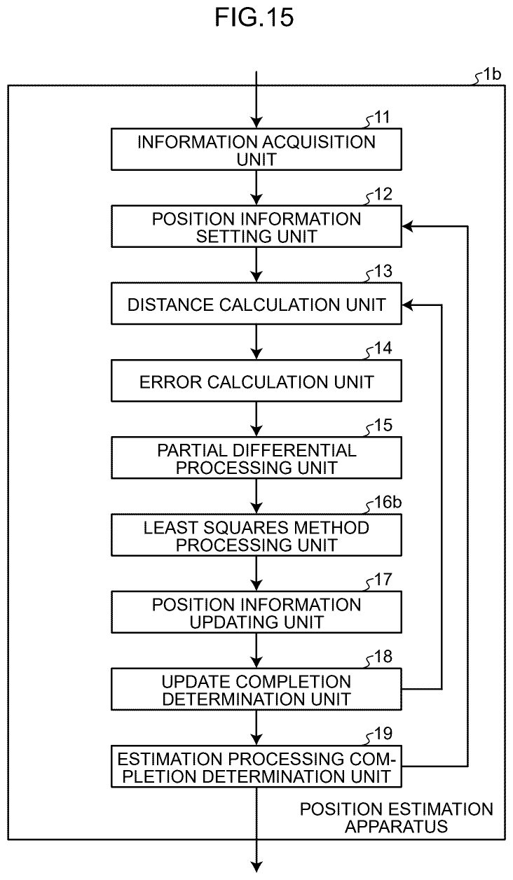

FIG. 15 is a diagram illustrating an exemplary configuration of a position estimation apparatus 1b according to a fourth embodiment. Note that assume that the position estimation apparatus 1b is provided in the mobile station 100 similarly to the position estimation apparatus 1 according to the first embodiment, but the mobile station 100 is not illustrated in FIG. 15.

The position estimation apparatus 1b has a configuration in which the least squares method processing unit 16 of the position estimation apparatus 1 according to the first embodiment is replaced with a least squares method processing unit 16b. That is, the position estimation apparatus 1b is different from the position estimation apparatus 1 according to the first embodiment in the least squares method processing used for estimating the position of the mobile station 100. The components other than the least squares method processing unit 16b of the position estimation apparatus 1b are the same as the components, which are denoted by the identical reference signs, of the position estimation apparatus 1 according to the first embodiment. Thus, the description of the components other than the least squares method processing unit 16b will be omitted.

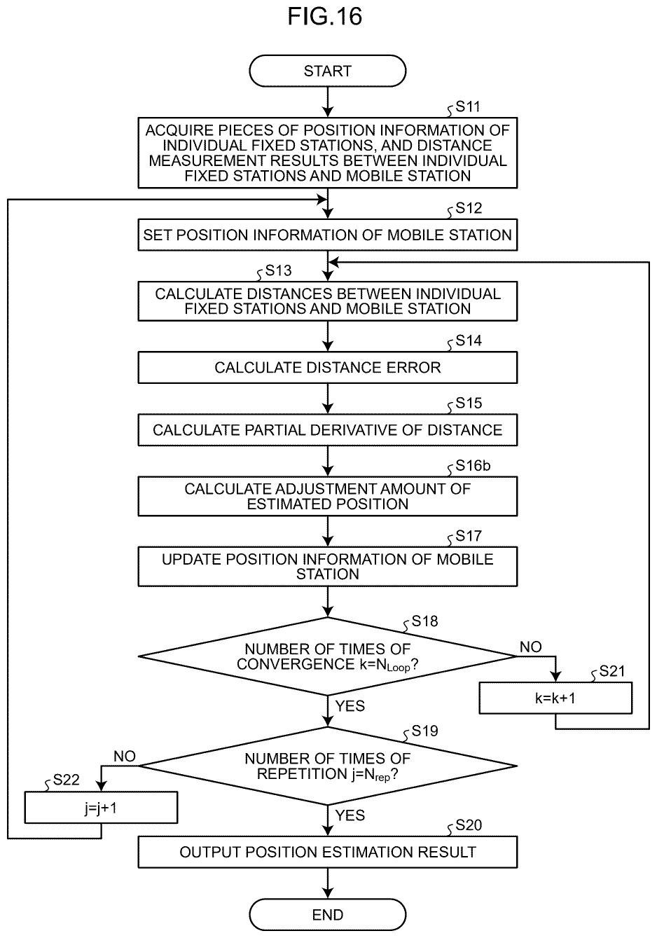

FIG. 16 is a flowchart illustrating an example of an operation in which the position estimation apparatus 1b according to the fourth embodiment estimates a position of the mobile station 100. The flowchart illustrated in FIG. 16 is obtained by replacing, with step S16b, step S16 in the flowchart of FIG. 6 illustrating the operation in which the position estimation apparatus 1 according to the first embodiment performs position estimation. The pieces of processing of the steps other than step S16b of the position estimation apparatus 1b according to the fourth embodiment are similar to the pieces of processing, which are assigned with the identical step numbers, of the position estimation apparatus 1 according to the first embodiment. Thus, the description of the pieces of processing of the steps other than step S16b will be omitted.

In step S16b, similarly to the least squares method processing unit 16 of the position estimation apparatus 1 according to the first embodiment, the least squares method processing unit 16b calculates the adjustment amount of the estimated position of the mobile station 100 using the least squares method. However, the least squares method processing unit 16b is partially different in calculation method from the least squares method processing unit 16.

In the least squares method processing unit 16 of the position estimation apparatus 1 according to the first embodiment, the unweighted least squares method processing is executed when the number of times of repetition j is j=1, and the least squares method processing of performing weighting inversely proportional to the square of the distance error is executed when the number of times of repetition j is 1<j. On the other hand, in the least squares method processing unit 16b of the position estimation apparatus 1b according to the fourth embodiment, the least squares method processing of performing the weighting is executed even when the number of times of repetition j is j=1. Consequently, as compared with the least squares method processing unit 16, the least squares method processing unit 16b enables a further reduction in the influence of the distance measurement result, between the fixed station and the mobile station 100, having a large distance measurement error due to the reflected wave or the like, thus improving the accuracy of the estimation of the position.

When the number of times of repetition j is j=1, the least squares method processing unit 16b performs the weighted least squares method processing using the weighting coefficient Wᵢ expressed by Formula (16) below.

$$\begin{matrix}Formula 16 & \\ {W}_{i} = \{ \begin{matrix}1 , & {( Δ {r}_{{i}_{( k )}} )}^{2} < {σ}_{Da}^{2} \\ {σ}_{Da}^{2} / {( Δ {r}_{{i}_{( k )}} )}^{2} , & {σ}_{Da}^{2} \leq {( Δ {r}_{{i}_{( k )}} )}^{2} \leq {σ}_{Ua}^{2} \\ {σ}_{Da}^{2} / {σ}_{Ua}^{2} , & {( Δ {r}_{{i}_{( k )}} )}^{2} > {σ}_{Ua}^{2}\end{matrix} & ( 16 )\end{matrix}$$

Additionally, when the number of times of repetition j is 1<j, the least squares method processing unit 16b performs the weighted least squares method processing using the weighting coefficient Wᵢ expressed by Formula (17) below.

$$\begin{matrix}Formula 17 & \\ {W}_{i} = \{ \begin{matrix}1 , & {( Δ {r}_{{i}_{( k )}} )}^{2} < {σ}_{Db}^{2} \\ {σ}_{Db}^{2} / {( Δ {r}_{{i}_{( k )}} )}^{2} , & {σ}_{Db}^{2} \leq {( Δ {r}_{{i}_{( k )}} )}^{2} \leq {σ}_{Ub}^{2} \\ {σ}_{Db}^{2} / {σ}_{Ub}^{2} , & {( Δ {r}_{{i}_{( k )}} )}^{2} > {σ}_{Ub}^{2}\end{matrix} & ( 17 )\end{matrix}$$

In Formula (16) and Formula (17), i represents a fixed station number, where i=0, 1, . . . , N−1. Furthermore, σ_{Da}², σ_{Ua}², σ_{Db}², and σ_{Ub}² that mean the allowable variance of the distance measurement errors, respectively represent the lower limit value of (Δrᵢ₍ₖ₎)², the upper limit value of (Δrᵢ₍ₖ₎)², the lower limit value of (Δrᵢ₍ₖ₎)², and the upper limit value of (Δrᵢ₍ₖ₎)². Here, relationships of σ_{Da}²>σ_{Db}² and σ_{Ua}²<σ_{Ub}² are established.

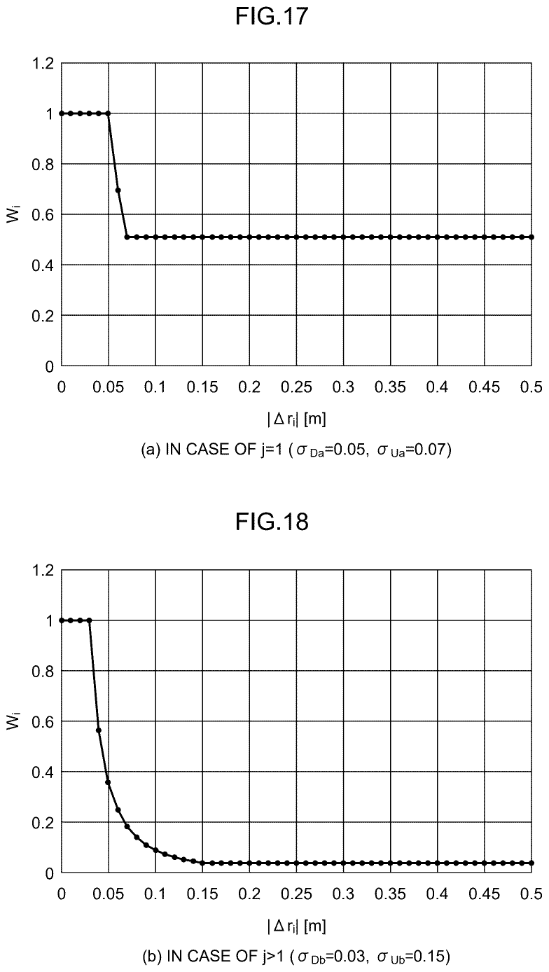

A specific example of the weighting coefficient Wᵢ expressed by Formula (16) and Formula (17) will be described with reference to FIGS. 17 and 18. FIG. 17 is a diagram illustrating a first example of a weighting coefficient used in least squares method processing in the position estimation apparatus 1b according to the fourth embodiment. Specifically, FIG. 17 illustrates an example of the weighting coefficient Wᵢ used in the case of j=1. FIG. 18 is a diagram illustrating a second example of the weighting coefficient used in the least squares method processing in the position estimation apparatus 1b according to the fourth embodiment. Specifically, FIG. 18 illustrates an example of the weighting coefficient Wᵢ used in a case of j>1.

In FIGS. 17 and 18, the horizontal axis represents the absolute value of the distance measurement errors, and the vertical axis represents the weighting coefficient. σ_{Da} and σ_{Db} are lower limit values of the absolute value of the distance error Δrᵢ, and in FIGS. 17 and 18, as an example, σ_{Da}=0.05 and σ_{Db}=0.03 are set. Additionally, σ_{Ua} and σ_{Ub} are upper limit values of the absolute value of the distance error Δrᵢ, and in FIGS. 17 and 18, as an example, σ_{Ua}=0.07 and σ_{Ub}=0.15 are set.

Comparing FIG. 17 with FIG. 18, FIG. 17 illustrating a case where the number of times of repetition j is j=1 has a larger section in which the weighting coefficient Wᵢ is Wᵢ=1, which is the upper limit value. Thus, it is possible to prevent a decrease in the value of the weighting coefficient Wᵢ due to variations in the distance measurement errors between the fixed stations and the mobile station 100. Additionally, the value of the weighting coefficient Wᵢ can be set larger in FIG. 17 under the condition of (Δrᵢ₍ₖ₎)²>σ_{Ua}².

By setting the weighting coefficient Wᵢ as described above, in a case where the number of times of repetition j is j=1, even in a situation where there is a large variation in the distance measurement errors between the fixed stations and the mobile station 100, it is possible to use the least squares method, in which weighting is performed, for the distance measurement results between the fixed stations and the mobile station 100 in accordance with the distance measurement errors while reducing the influence of the large distance measurement error due to the reflected wave.

As described above, in the position estimation apparatus 1b according to the fourth embodiment, even when the number of times of repetition j described in the first embodiment is j=1, the least squares method processing of performing weighting using the weighting coefficient Wᵢ different from the case of 1<j is executed. Consequently, it is possible to prevent a decrease in the value of the weighting coefficient due to the variations in the distance measurement errors between the fixed stations and the mobile station 100, and it is possible to reduce the influence of a large distance measurement error due to the reflected wave, thus improving the accuracy of the estimation of the position.

### Fifth Embodiment

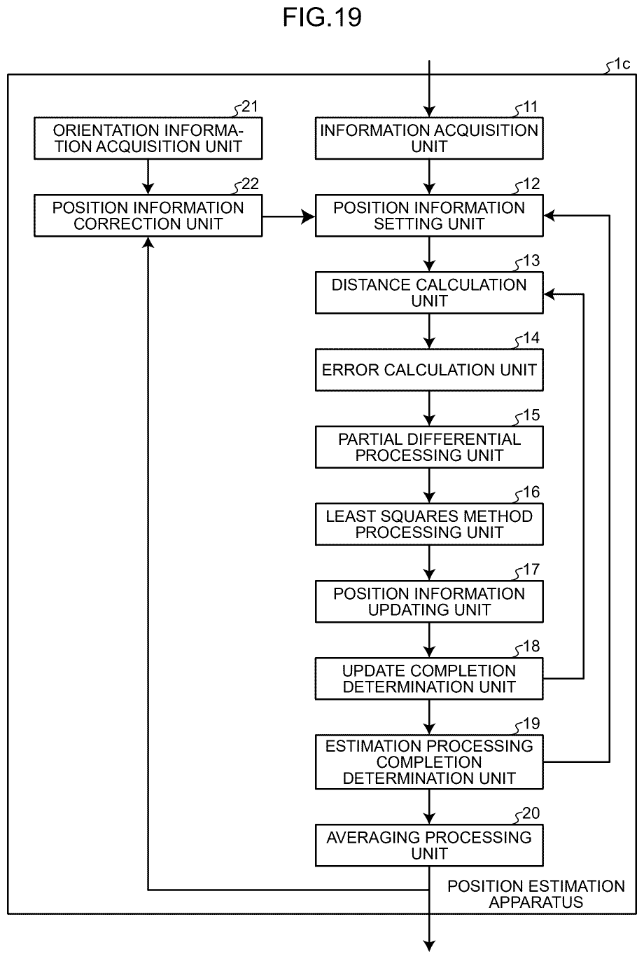

FIG. 19 is a diagram illustrating an exemplary configuration of a position estimation apparatus 1c according to a fifth embodiment. Note that assume that the position estimation apparatus 1c is provided in the mobile station 100 similarly to the position estimation apparatus 1 according to the first embodiment, but the mobile station 100 is not illustrated in FIG. 19.

The position estimation apparatus 1c has a configuration in which an orientation information acquisition unit 21 and a position information correction unit 22 are added to the position estimation apparatus 1a according to the second embodiment illustrated in FIG. 9. The components other than the orientation information acquisition unit 21 and the position information correction unit 22 of the position estimation apparatus 1c are the same as the components, which are denoted by the identical reference signs, of the position estimation apparatus 1a according to the second embodiment. Thus, the description of the components other than the orientation information acquisition unit 21 and the position information correction unit 22 will be omitted.

The orientation information acquisition unit 21 acquires orientation information of the mobile station 100. The orientation information is, for example, acceleration information, azimuth information, geomagnetic information, or the like, and is calculated using a sensing result from a sensor installed in the mobile station 100. The acquisition cycle of the orientation information by the orientation information acquisition unit 21 is shorter than the cycle in which the information acquisition unit 11 acquires the pieces of position information of the individual fixed stations and executes the position estimation operation for the mobile station 100.

The position information correction unit 22 corrects, based on the orientation information, the position information indicating the position estimation result of the mobile station 100 output from the averaging processing unit 20. The position information correction unit 22 outputs the corrected position information to the position information setting unit 12 at a predetermined timing. For example, the position information correction unit 22 outputs the corrected position information to the position information setting unit 12 at a timing when the position estimation operation for the mobile station 100 is started and the position information setting unit 12 sets the initial value of the position information of the mobile station 100. That is, the position information corrected by the position information correction unit 22 is used as an initial value of the position information of the mobile station 100 in the next position estimation operation. Note that, as described above, since the cycle in which the orientation information acquisition unit 21 acquires the orientation information is shorter than the cycle in which the position estimation operation is executed, the position information correction unit 22 corrects the position information based on the latest orientation information, for example, every time the orientation information acquisition unit 21 acquires the orientation information. At this time, the position information correction unit 22 may correct the position information based on the latest orientation information and the past orientation information. The position information correction unit 22 may hold the position information received from the averaging processing unit 20 and the plurality of pieces of orientation information repeatedly received from the orientation information acquisition unit 21, correct, when the information acquisition unit 11 acquires the pieces of position information of the individual fixed stations, the position information held at that time based on the pieces of held orientation information, and output the corrected position information to the position information setting unit 12. Alternatively, the position information correction unit 22 may hold the position information received from the averaging processing unit 20, correct the held position information based on the latest orientation information first acquired by the orientation information acquisition unit 21 after the information acquisition unit 11 acquires the pieces of position information of the individual fixed stations, and output the corrected position information to the position information setting unit 12. Whether the orientation information used to correct the position information is only the latest orientation information or a plurality of pieces of orientation information including the latest orientation information may be determined in accordance with the type of the orientation information.

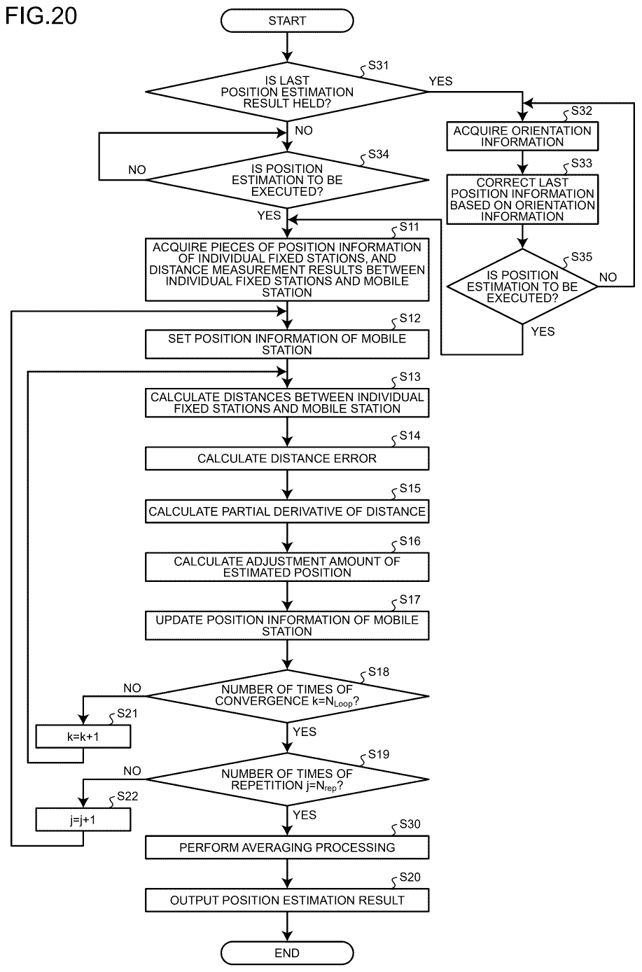

FIG. 20 is a flowchart illustrating an example of an operation in which the position estimation apparatus 1c according to the fifth embodiment estimates a position of the mobile station 100. The flowchart illustrated in FIG. 20 is obtained by adding steps S31 to S35 to the flowchart of FIG. 10 illustrating the operation in which the position estimation apparatus 1a according to the second embodiment performs position estimation. The pieces of processing of the steps other than steps S31 to S35 of the position estimation apparatus 1c according to the fifth embodiment are similar to the pieces of processing, which are assigned with the identical step numbers, of the position estimation apparatus 1a according to the second embodiment. Thus, the description of the pieces of processing of the steps other than steps S31 to S35 will be omitted.

The position estimation apparatus 1c executes steps S31 to S35 before executing step S11. That is, the position estimation apparatus 1c first confirms whether the last position estimation result is held (step S31). Specifically, the position estimation apparatus 1c confirms whether there is the position information output from the averaging processing unit 20 to the position information correction unit 22 in the last position estimation operation for the mobile station 100. When the last position estimation result is not held (step S31: No), the position estimation apparatus 1c confirms whether to execute position estimation (step S34). The position estimation apparatus 1c determines to execute position estimation when a predetermined condition is satisfied. When not executing the position estimation (step S34: No), the position estimation apparatus 1c repeats step S34 and stands by until the timing to execute the position estimation comes. When executing the position estimation (step S34: Yes), the position estimation apparatus 1c executes step S11. Thereafter, the position estimation apparatus 1c proceeds to step S12, and the position information setting unit 12 sets the initial value of the position information of the mobile station 100 using the method described in the first embodiment or the like.

On the other hand, when the last position estimation result is held (step S31: Yes), the position information correction unit 22 acquires the orientation information of the mobile station 100 from the orientation information acquisition unit 21 (step S32), and corrects the last position information based on the orientation information (step S33). The last position information is the aforementioned last position estimation result. For example, when the orientation information includes pieces of information about the acceleration and the azimuth of the mobile station 100, the position information correction unit 22 corrects the last position information by using these pieces of information and the elapsed time from the acquisition of the last position information.

After correcting the last position information in step S33, the position estimation apparatus 1c confirms whether to execute position estimation (step S35). The processing of step S35 is similar to that of step S34 described above. When not executing the position estimation (step S35: No), the position estimation apparatus 1c returns to step S32, and repeats steps S32 and S33. Note that, in step S33 at this time, the position information corrected in step S33 executed last time is corrected based on the latest orientation information acquired in step S32. As described above, in a case where the last position estimation result (position information) is held, the position estimation apparatus 1c repeats the processing of correcting the position information based on the orientation information of the mobile station 100 until the timing to execute the position estimation comes. When executing the position estimation (step S35: Yes), the position estimation apparatus 1c executes step S11. In step S12 executed subsequent to step S11 at this time, the position information setting unit 12 sets the last position information corrected by the position information correction unit 22 as the initial value of the position information of the mobile station 100.

As described above, when the last position information indicating the estimation result obtained by the last position estimation operation exists, the position estimation apparatus 1c according to the fifth embodiment sets the corrected position information obtained by correcting the last position information based on the orientation information of the mobile station 100 as the initial value of the position information of the mobile station 100 in the position estimation operation to be newly executed. In the position estimation apparatus 1 according to the first embodiment, the estimation is performed by the least squares method, in which the weighting is not performed, in the case of the position estimation for the first time (the repetition processing of steps S12 to S17 for the first time). However, in the position estimation apparatus 1c according to the fifth embodiment, since the position information corrected using the orientation information can be estimated as the initial value, the weighted least squares method can be performed from the beginning. Additionally, since the last position information corrected based on the orientation information is used as the initial value, position estimation with improved convergence speed can be achieved as compared with the second embodiment in which the last position information not to be subjected to correction is used as the initial value.

Note that, in the present embodiment, the example has been described in which the orientation information acquisition unit 21 and the position information correction unit 22 are added to the position estimation apparatus 1a according to the second embodiment. However, the orientation information acquisition unit 21 and the position information correction unit 22 may be added to the position estimation apparatus 1 according to the first embodiment. In this case, it is sufficient that when outputting the position estimation result to the outside, the estimation processing completion determination unit 19 also outputs the position estimation result to the position information correction unit 22.

Next, a description will be given of a hardware configuration of the fixed stations 210 to 213 and the mobile station 100, in which the position estimation apparatus 1, 1a, 1b, or 1c is to be provided, described in the first to fifth embodiments. The fixed stations 210 to 213 and the mobile station 100, in which the position estimation apparatus 1, 1a, 1b, or 1c is to be provided, according to the first to fifth embodiments include processing circuitry. This processing circuitry executes the pieces of processing for performing position estimation described in each of the first to fifth embodiments, thereby implementing respective functions of the fixed stations 210 to 213 and the position estimation apparatuses 1, 1a, 1b, and 1c according to the first to fifth embodiments.

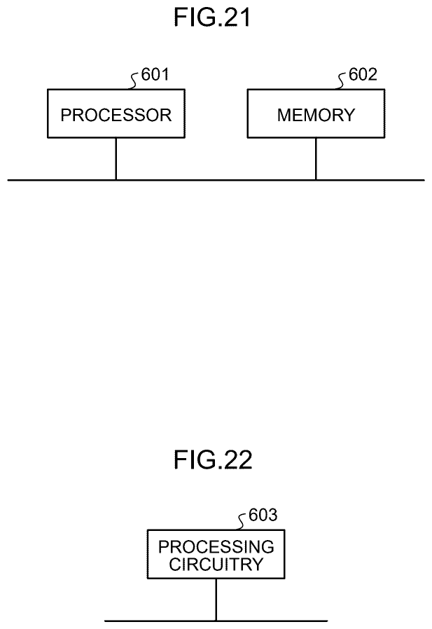

FIG. 21 is a diagram illustrating an example of a case where a processor and a memory constitute processing circuitry included in the fixed stations 210 to 213 or the mobile station 100 according to the first to fifth embodiments. In a case where the processing circuitry includes a processor 601 and a memory 602, the respective functions of the processing circuitry included in the fixed stations 210 to 213 or the mobile station 100 are implemented by software, firmware, or a combination of software and firmware. The software or firmware is described as a program and stored in the memory 602. In the processing circuitry, the processor 601 reads and executes the programs stored in the memory 602 to implement the respective functions. That is, the processing circuitry includes the memory 602 for storing programs with which the pieces of processing of the fixed stations 210 to 213 or the mobile station 100 are executed as a result. It can also be said that the programs are programs for causing a computer to execute processing procedures or methods of the fixed stations 210 to 213 or the mobile station 100. Note that the programs stored in the memory 602 may be provided by a storage medium storing the programs or may be provided via a communication path.

Here, the processor 601 may be, for example, a Central Processing Unit (CPU), a processing unit, an arithmetic unit, a microprocessor, a microcomputer, or a Digital Signal Processor (DSP). Additionally, the memory 602 corresponds to, for example, a nonvolatile or volatile semiconductor memory such as a Random Access Memory (RAM), a Read Only Memory (ROM), a flash memory, an Erasable Programmable ROM (EPROM), or an Electrically EPROM (EEPROM, registered trademark), a magnetic disk, a flexible disk, an optical disk, a compact disk, a mini disk, a Digital Versatile Disc (DVD), or the like.

Additionally, the processing circuitry included in the fixed stations 210 to 213 or the mobile station 100 according to the first to fifth embodiments may be configured using dedicated hardware.

FIG. 22 is a diagram illustrating an example of a case where dedicated hardware constitutes processing circuitry included in the fixed stations 210 to 213 or the mobile station 100 according to the first to fifth embodiments. In a case where the processing circuitry includes dedicated hardware, the processing circuitry 603 illustrated in FIG. 22 corresponds to, for example, a single circuit, a combined circuit, a programmed processor, a parallel-programmed processor, an Application Specific Integrated Circuit (ASIC), a Field Programmable Gate Array (FPGA), or any combination thereof. The respective functions of the fixed stations 210 to 213 or the mobile station 100 may be implemented by the processing circuitry 603 on a function-by-function basis, or the respective functions may be collectively implemented by the processing circuitry 603.

Note that some of the respective functions of the fixed stations 210 to 213 or the mobile station 100 according to the first to fifth embodiments may be implemented by dedicated hardware, and some may be implemented by software or firmware. In this manner, the processing circuitry can implement the above-described respective functions using dedicated hardware, software, firmware, or any combination thereof.

The position estimation apparatus according to the present disclosure has an effect of being able to perform highly accurate position estimation even in the environment where the accuracy of distance measurement based on the transmission and reception timing of the signal decreases due to the influence of the reflected wave or the like.

The features illustrated in connection with the above embodiments are illustrative only and may be combined with the other known techniques. The embodiments may be combined with each other. The features may partially be omitted or modified without departing from the gist.

What is claimed is:

1. A position estimator to estimate a position of a mobile station based on distance measurement results between a plurality of individual fixed stations and the mobile station, the distance measurement results being derived based on results of wireless communication between the plurality of individual fixed stations and the mobile station, the position estimator comprising:
a distance calculation circuitry to calculate, for each of the fixed stations, an estimated distance based on an estimated position of the mobile station and positions of the plurality of fixed stations, the estimated distances being distances between the plurality of individual fixed stations and the mobile station;
an error calculation circuitry to calculate, for each of the fixed stations, an error between the distance measurement results and the estimated distances;
an estimated position adjustment amount calculation circuitry to calculate an adjustment amount of the estimated position based on distance errors and partial differentiation results of the estimated distances, the distance errors being the errors calculated by the error calculation circuitry; and
a position information updating circuitry to update, based on the adjustment amount, position information indicating the estimated position, wherein
the position estimator repeatedly executes estimated position update processing a predetermined number of times, thus estimating a position of the mobile station, the estimated position update processing including processing in which the distance calculation circuitry calculates the estimated distance for each of the fixed stations, processing in which the error calculation circuitry calculates the error for each of the fixed stations, processing in which the estimated position adjustment amount calculation circuitry calculates the adjustment amount, and processing in which the position information updating circuitry updates the position information.

2. The position estimator according to claim 1, wherein
the estimated position adjustment amount calculation circuitry calculates the adjustment amount using a least squares method in which weighting inversely proportional to a square value of each of the distance errors is performed.

3. The position estimator according to claim 2, wherein
the estimated position adjustment amount calculation circuitry calculates the adjustment amount using a least squares method, in which the weighting is not performed, in the estimated position update processing for a first time, and calculates the adjustment amount using a least squares method, in which weighting inversely proportional to a square of each of the distance errors is performed, in the estimated position update processing for second and subsequent times.

4. The position estimator according to claim 2, wherein
a weighting coefficient used in the weighting is set, based on the square value of each of the distance errors, to a value within a range that is greater than or equal to a predetermined minimum value and less than or equal to a predetermined maximum value.

5. The position estimator according to claim 1, wherein
when the estimated position update processing is repeatedly executed the predetermined number of times, a position indicated by the position information obtained and updated through the repeatedly executing is set as a new estimated position of the mobile station, and position estimation processing of repeatedly executing the estimated position update processing the predetermined number of times is executed a predetermined number of times.

6. The position estimator according to claim 2, wherein
when the estimated position update processing is repeatedly executed the predetermined number of times, a position indicated by the position information obtained and updated through the repeatedly executing is set as a new estimated position of the mobile station, position estimation processing of repeatedly executing the estimated position update processing the predetermined number of times is executed a predetermined number of times,
a weighting coefficient used in the weighting is set, based on the square value of each of the distance errors, to a value within a range that is greater than or equal to a predetermined minimum value and less than or equal to a predetermined maximum value, and
a weighting coefficient used in the weighting in the position estimation processing for a first time is a minimum value when the square value of the distance error is less than or equal to a first value, and a weighting coefficient used in the weighting in the position estimation processing for second and subsequent times is a minimum value when the square value of the distance error is less than or equal to a second value smaller than the first value.

7. The position estimator according to claim 5, comprising an averaging processing circuitry to perform averaging processing on the position information obtained by executing the position estimation processing the predetermined number of times, wherein
the position information subjected to the averaging processing is used as a position estimation result of the mobile station.

8. The position estimator according to claim 7, comprising:
an orientation information acquisition circuitry to acquire orientation information of the mobile station; and
a position information correction circuitry to correct, based on the orientation information, the position information subjected to the averaging processing by the averaging processing circuitry, wherein
when a position estimation operation of estimating the position of the mobile station by repeatedly executing the position estimation processing is started, corrected position information obtained by subjecting the position information obtained in a last position estimation operation to the averaging processing by the averaging processing circuitry and the correction by the position information correction circuitry is set as an initial value of the position information of the mobile station.

9. A position estimation system comprising:
the mobile station including the position estimator according to claim 1; and
the fixed stations.

10. A position estimation method for estimating, by a position estimator, a position of a mobile station based on distance measurement results between a plurality of individual fixed stations and the mobile station, the distance measurement results being derived based on results of wireless communication between the plurality of individual fixed stations and the mobile station, the position estimation method comprising estimating a position of the mobile station by repeatedly executing a predetermined number of times:
calculating, for each of the fixed stations, an estimated distance based on an estimated position of the mobile station and positions of the plurality of fixed stations, the estimated distances being distances between the plurality of individual fixed stations and the mobile station;
calculating, for each of the fixed stations, an error between the distance measurement results and the estimated distances;
calculating an adjustment amount of the estimated position based on distance errors and partial differentiation results of the estimated distances, the distance errors being the errors calculated; and
updating, based on the adjustment amount, position information indicating the estimated position.

11. A control circuit to control a position estimator to estimate a position of a mobile station based on distance measurement results between a plurality of individual fixed stations and the mobile station, the distance measurement results being derived based on results of wireless communication between the plurality of individual fixed stations and the mobile station, the control circuit causing the position estimator to execute processing of estimating a position of the mobile station by repeatedly executing a predetermined number of times:
calculating, for each of the fixed stations, an estimated distance based on an estimated position of the mobile station and positions of the plurality of fixed stations, the estimated distances being distances between the plurality of individual fixed stations and the mobile station;
calculating, for each of the fixed stations, an error between the distance measurement results and the estimated distances;
calculating an adjustment amount of the estimated position based on distance errors and partial differentiation results of the estimated distances, the distance errors being the errors calculated; and
updating, based on the adjustment amount, position information indicating the estimated position.

12. A non-transitory computer-readable storage medium storing a program for controlling a position estimator to estimate a position of a mobile station based on distance measurement results between a plurality of individual fixed stations and the mobile station, the distance measurement results being derived based on results of wireless communication between the plurality of individual fixed stations and the mobile station, the program causing the position estimator to execute processing of estimating a position of the mobile station by repeatedly executing a predetermined number of times:
calculating, for each of the fixed stations, an estimated distance based on an estimated position of the mobile station and positions of the plurality of fixed stations, the estimated distances being distances between the plurality of individual fixed stations and the mobile station;
calculating, for each of the fixed stations, an error between the distance measurement results and the estimated distances;
calculating an adjustment amount of the estimated position based on distance errors and partial differentiation results of the estimated distances, the distance errors being the errors calculated; and
updating, based on the adjustment amount, position information indicating the estimated position.
